(19) United States
(12) Patent Application Publication
(10) Pub. No.: US 2008/0090724 A1
(43) Pub. Date: Apr. 17, 2008

(54) Date-coding system and method

(76) Inventor: John D. Mistyurik, Troy, OH (US)

Correspondence Address: PAXAR AMERICAS, INC.;ATTN: JOSEPH J. GRASS, 170 MONARCH LANE, MIAMISBURG, OH, 45342, US

(21) Appl. No.: 11/546,234

(22) Filed: Oct. 11, 2006

(51) Int. Cl. B41M 5/24

(52) U.S. Cl. 503/207

(57) ABSTRACT

There is disclosed a composite label web and method of date coding, whether pre-printed color-coded labels can be overprinted in a hand held portable thermal labeler to enable a color relating to a selected day of the week to be highlighted and date-related information to be encoded.

### CROSS-REFERENCE TO RELATED APPLICATION

A related application is application Ser. No. 11/471,902, filed Jun. 21, 2006.

### BACKGROUND OF THE INVENTION

1. Field of the Invention

This invention relates to the field of date-coded labels and method of date coding.

2. Brief Description of the Prior Art

It is known to use date coding in connection with perishable goods such as meats and produce to indicate expiration times and/or dates. The date code can be applied either to the goods or to packaging for the goods. It is known to date code by words, numbers and/or colors. When colors are used, there is a different color to designate each day of the week. One such system in use in the United States for color-coding perishable goods designates blue for Monday, yellow for Tuesday, red for Wednesday, brown for Thursday, green for Friday, orange for Saturday and black for Sunday.

The following prior art is made of record: U.S. Pat. Des. 514,154; U.S. Pat. No. 4,113,544; U.S. Pat. No. 4,846,503; U.S. Pat. No. 5,708,462; U.S. Pat. No. 5,462,909; and U.S. Pat. No. 5,910,227.

It is known to date code by using an electronic thermal table-top printer to overprint adhesive backed labels which were preprinted with colors in zones, with a different colored zone for each of six days of the week and the color black for Sunday was printed by thermal direct printing. All of the colored zones of up to six days of the week are obliterated by overprinting by thermal direct printing, except for the colored zone representative of a selected day of the week. In either case, the name of the day of the week was thermally printed adjacent to the colored zone corresponding to the selected day of the week. This arrangement required substantial investment and required that the user return to the thermal printer at a fixed location each time the user needed a label or labels.

### SUMMARY OF THE INVENTION

Use of the label web of the invention in a hand-held thermal printer enables the user to print, dispense and apply date coding labels at the rate where they are to be applied without the user having to go back and forth between a stationary printer and the site of application.

A specific embodiment of a method of date coding comprises providing a hand-held, portable thermal labeler including a hand-held portable housing, the housing having a label roll space, a thermal print head to print on thermal labels and an applicator roll for applying printed labels, providing a composite label web in roll form in the label roll space, the composite label web including a carrier web having a release coating, a series of labels having opposite faces, a coating of pressure sensitive adhesive on one face of each label releasably adhered to the release coating, the other face of each label having a thermal coating, each label having a set of seven printed zones over the thermal coating, the seven zones being comprised of seven different colors representative of seven days of the week, printing at least one mark adjacent one and only one selected zone to highlight the selected day of the week.

According to a specific embodiment, there is provided an improved label web capable of being printed in a thermal hand-held labeler, wherein the label web has a carrier web with a release coating, a series of labels with opposite faces, a coating of pressure sensitive adhesive on one face of each label releasably adhered to the release coating, and the other face of each label having a thermal coating. Each label having a set of seven printed zones over the thermal coating, the seven zones being of seven different colors representative of seven days of the week, and at least one label having at least one thermally printed mark adjacent one and only selected zone to highlight the selected day of the week without obliterating any zone.

### BRIEF DESCRIPTION OF THE DIAGRAMMATIC DRAWINGS

FIG. 1 is a fragmentary top plan view of a composite label web used for date coding;

FIG. 2 is a fragmentary bottom plan view of the composite label web;

FIG. 3 is an enlarged sectional view taken along line 3-3 of FIG. 1;

FIG. 4 is a perspective view of a thermal hand-held portable labeler used to print and apply date-coding pressure sensitive thermal labels from the composite label web; and

FIG. 5 is a fragmentary partly sectional view of the hand-held portable thermal labeler shown in FIG. 4.

### DETAILED DESCRIPTION OF THE PREFERRED EMBODIMENTS

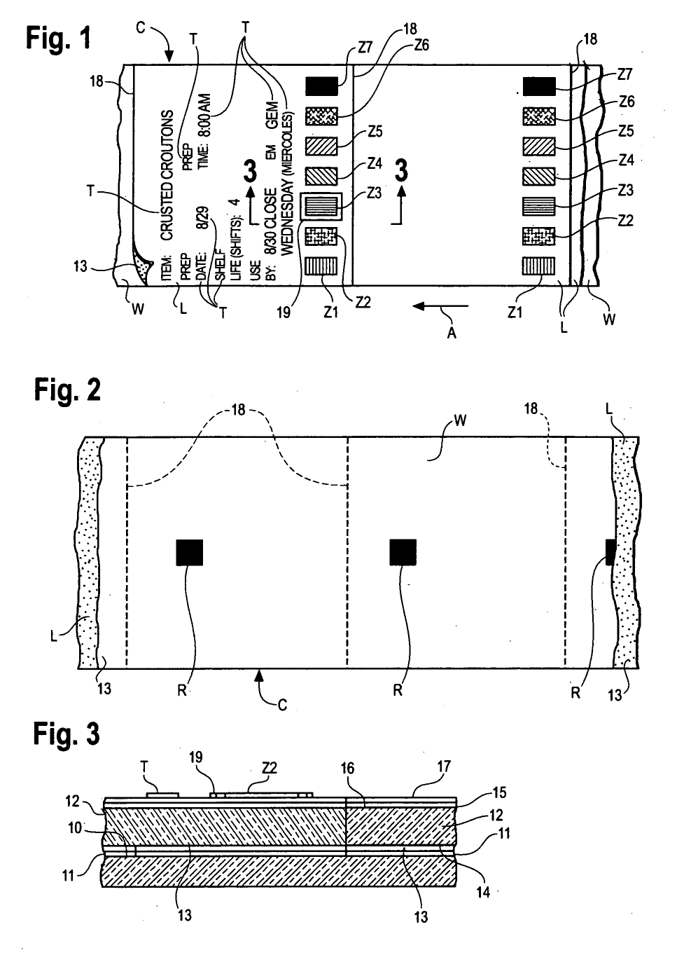

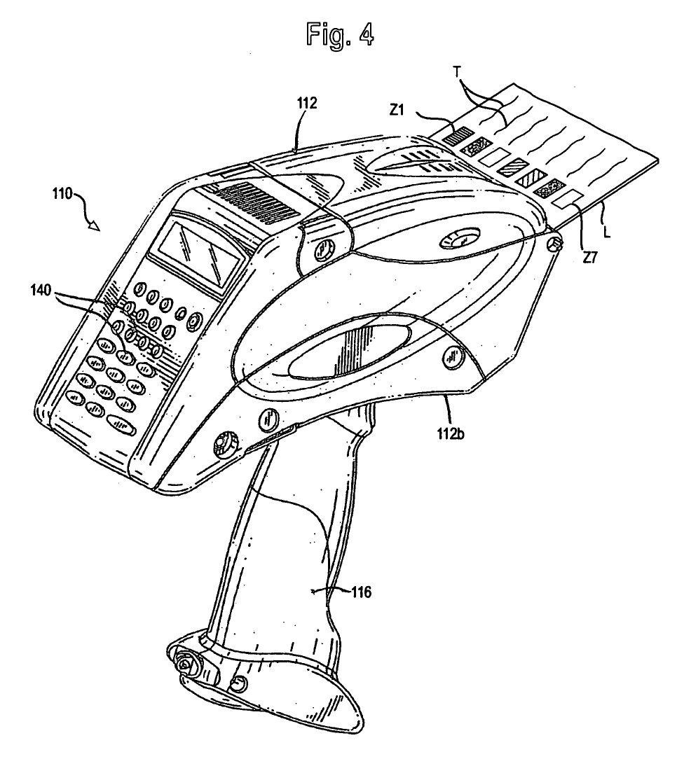

With reference to FIGS. 1 and 3, there is disclosed a longitudinally extending composite label web C including labels L releasably adhered to a longitudinally extending carrier web W. Upper surface 10 of the carrier web is provided with a uniform coating of a release material such as silicone 11. The labels L are comprised of label material 12. Pressure sensitive or tacky adhesive 13 is adhered to lower surface 14 of the label material 12. A uniform thermal coating 15 is applied to upper surface 16 of the label material 12. An optional barrier coating 17 can be applied over the thermal coating 15.

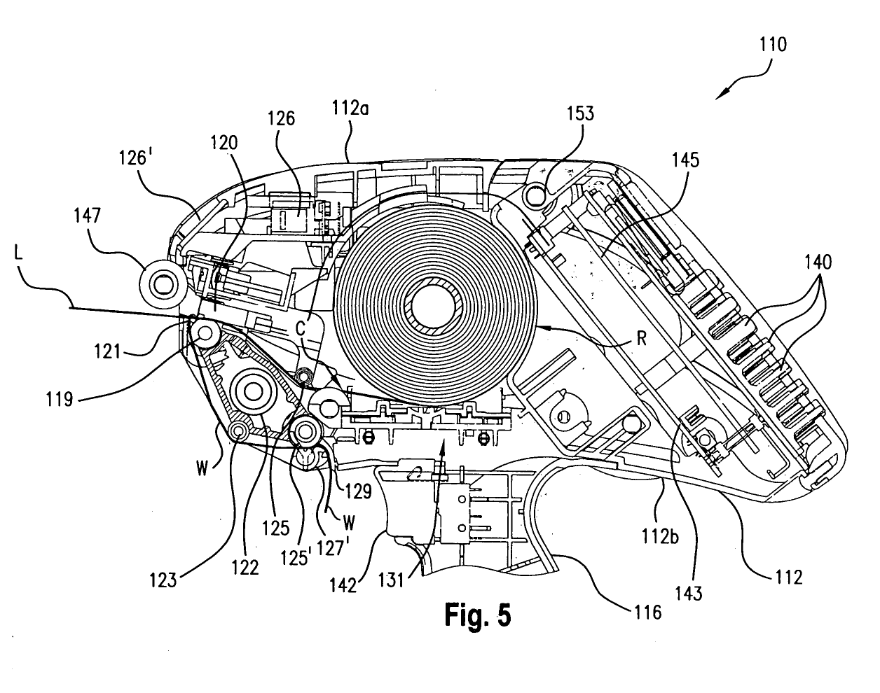

The composite label web C is paid out of a roll R (FIG. 5) and can be printed in a thermal hand-held portable labeler shown in FIGS. 4 and 5. Lines of complete severing 18 (FIGS. 1 and 2) are shown to divide the label material 12 into end-to-end labels L. The labels L in the roll R can be preprinted with zones Z1 through Z7 during the label making process. According to one convention, the days of the week Monday through Sunday are represented by the colors blue for Monday, yellow for Tuesday, red for Wednesday, brown for Thursday, Green for Friday, orange for Saturday and black for Sunday in zones Z1 through Z7, respectively. The zones Z1 through Z7 are printed directly onto the barrier coating 17, or if a barrier coating 17 is omitted, then directly onto the thermal coating 15. The zones Z1 through Z7 are shown to be generally rectangular with the long dimension extending longitudinally, although other shapes such as circular, square and so forth can be used instead. The labels can be printed with text T as shown in FIG. 1 and/or with graphics, bar codes and other indicia.

FIG. 3 shows the underside of the composite web C with printed registration marks as in U.S. Pat. No. 5,708,462 for registering the labels L in the labeler.

With reference to FIG. 1, the composite label web is shown to move in the direction of arrow A. The leading label L, is shown to have been encoded by thermally printing a highlighting mark 19 around the zone Z3 representative by color of Wednesday. The mark 19 is shown to be a rectangle formed by a continuous line but the line can be intermittent, or a different mark such as an arrow (not shown) pointing to the zone Z3 can be used. Also the zones Z1 through Z7 can be circles and the marks 19 can be larger circles. The mark 19 shown to be slightly spaced from zone Z3, but it can be a continuous border around zone Z3 if desired. The mark 19 can be used to highlight any selected zone Z1 through Z7. There can be encoding of text T relating to date coding as shown in FIG. 1.

The composite label web C is shown in FIGS. 4 and 5 to be used in a hand-held portable thermal label printer or labeler 110. The composite label web passes from the roll R beneath a roller 125 to between a platen roll 119 and a cooperating thermal print head 120 to print on the labels. L. An electric motor 122 drives the platen roll 119 while the print head 120 prints. The platen roll 119 advances the composite label web C to and beyond the platen roll to a delaminator 121. As the carrier web W makes a sharp bend about the delaminator 121, the label L projects from the front of the printer 110 beneath and in label applying relationship to an applicator 147 shown to be in the form of an applicator roll. The carrier web W passes from there to and partially around a direction changing roll 123, from there the web W passes between a feed roll 125′ driven by the motor 122 and a back-up roll 127, and from there the web W passes out of the printer through an exit opening 129.

As shown, the roll R is mounted in a space within the housing 112 on a label roll holder 131.

The printer 110 also includes a bar code scanner 126 aligned with a window 126′ for scanning bar codes and a radio card 145 for communicating with a host computer (not shown). The housing 112 includes a movable upper housing section 112a and a lower housing section 112b to which a handle 116 is attached. A keyboard 140 is used to enter data and a display 144 displays data, prompts and the like.

Other embodiments and modifications of the invention will suggest themselves to those skilled in the art, and all such of these as come within the spirit of this invention are included within its scope as best defined by the appended claims.

We claim:

1. Method of date coding, comprising:
providing a hand-held, portable thermal labeler including a hand-held portable housing, the housing having a label roll space, a thermal print head to print on thermal labels, and an applicator roll for applying printed labels,
providing a composite label web in roll form in the label roll space, the composite label web including a carrier web having a release coating, a series of labels having opposite faces, a coating of pressure sensitive adhesive on one face of each label releasably adhered to the release coating, the other face of each label having a thermal coating, each label having a set of seven printed zones over the thermal coating, the seven zones being comprised of seven different colors representative of seven days of the week, and
printing at least one mark adjacent one and only one selected zone to highlight the selected day of the week without obliterating any zone, and using the applicator to apply the date-coded printed label.

2. A composite label web, comprising:
a carrier web having a release coating,
a series of labels having opposite faces,
a coating of pressure sensitive adhesive on one face of each label releasably adhered to the release coating,
the other face of each label having a thermal coating, each label having a set of seven printed zones over the thermal coating, the seven zones being of seven different colors representative of seven days of the week, and
at least one label having at least one thermally printed mark adjacent one and only one selected zone to highlight the selected day of the week without obliterating any zone.

3. A composite label web as defined in claim 2,
wherein the printed mark comprises a continuous thermally printed line surrounding the selected zone.

4. A composite label web as defined in claim 2,
wherein the printed mark comprises a rectangle.
